(19) United States
(12) Patent Application Publication
(10) Pub. No.: US 2007/0204060 A1
(43) Pub. Date: Aug. 30, 2007

(54) Network control apparatus and network control method

(76) Inventors: Hidemitsu Higuchi, Ebina (JP); Yoshinori Watanabe, Chigasaki (JP); Takeshi Aimoto, Kawasaki (JP); Takashi Isobe, Machida (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/436,671

(22) Filed: May 19, 2006

(30) Foreign Application Priority Data
May 20, 2005 (JP) 2005-147948
Mar. 22, 2006 (JP) 2006-077978

(51) Int. Cl. G06F 15/16

(52) U.S. Cl. 709/234; 709/235

(57) ABSTRACT

A traffic statistical analysis processing unit is provided in a network control apparatus so as to detect an abnormal traffic. When the abnormal traffic is detected, a filter is set to a packet transfer processing unit so as to stop transferring operation of the abnormal traffic. At the same time, abnormal condition sensing information is superimposed on a statistical information packet, and the resulting statistical information packet is transmitted to a traffic analyzing apparatus.

### INCORPORATION BY REFERENCE

The present application claims priorities from Japanese applications JP2005-147948 filed on May 20, 2005, JP2006-077978 filed on Mar. 22, 2006, the contents of which are hereby incorporated by reference into this application.

### BACKGROUND OF THE INVENTION

1. Field of the Invention

The present invention generally relates to a network control apparatus and a network control method. More specifically, the present invention is directed to a network control apparatus and a network control method, capable of sensing abnormal traffics.

2. Description of the Related Art

Various sorts of services involving telephone and broadcasting services are started to be provided via IP networks, and thus, quality supervising techniques for traffics flowing through IP networks have been rapidly progressed. Sensing techniques and monitoring techniques of traffics have been standardized even in standardization organizations such as IFTF. Also, communication quality control functions using traffic analyzing techniques have been marketed as products.

A first description is made of a traffic monitoring method which is called as “sFlow” and whose standardization has been progressed by IFTF, and the like. This traffic monitoring method is described in “A Method for Monitoring Traffic in Switched and Routed Networks” written by P. Phaal, S. Panchen, and N. McKee, [online], September in 2001, IFTF, [retrieved on Apr. 19, 2005],

<URL:http://www.ietf.org/rfc/rfc3176.txt> (will be referred to as “non-patent publication 1” hereinafter). In sFlow, a router (or switch) executes a sampling process operation of packets (traffics) under transfer and cuts out the sampled packet so as to form a corresponding sFlow packet. The sFlow packet outputted from the router is sent to a traffic analyzing apparatus called as either a “collector” or an “analyzer”, and the traffic analyzing apparatus stores thereinto these sFlow packets, statistically analyzes these sFlow packets, and displays a result of the statistical analysis to a manager. A major subject of this sFlow technique is a packet measuring technique, and information elements of the sFlow packets which are transmitted by the router to the traffic analyzing apparatus have been mainly described in this sFlow technique. While analyzing functions are entrusted to traffic analyzing apparatus actually provided in respective vendors (there are products capable of mainly displaying analyzing functions), the analyzing functions are not equipped within the router apparatus in the sFlow technique.

Next, a description is made of a traffic monitoring method called as “CLEAR-Flow” as an example of a product in which a traffic analyzing technique is equipped in a router (or switch). This traffic monitoring method is described in “WHITE PAPER CLEAR-Flow”, [online], retrieved on Feb. 19, 2006, <URL: http://www.extremenetworkds.co.jp/download/Whitepaper/C LEAR-Flow_Wp.pdf> (will be referred to as “non-patent publication 2” hereinafter). An operation flow of “CLEAR-Flow” is constituted by three stages, namely, “observation”, “analysis”, and “response.” The traffic analyzing technique corresponds to the “observation” stage executed in the router. In the “observation” stage, such a packet which is made coincident with an observation basis is focused; when the packet coincident with the observation basis is found out (step 1-filter), a condition of an occurrence is traced by employing an event counter (step 2-count); and when the occurring condition exceeds a present threshold value, a set action is executed (step 3-threshold value). As a result of the “observation” stage, when the relevant traffic is detected, the operation flow is advanced to the “analysis” stage. In this “analysis” stage, such an operation required in the case that a more precise analysis is required is carried, and the router transmits relevant traffic packet data to an external apparatus equipped with a higher analyzing function. As methods for transferring this traffic packet data, there are three transferring methods, namely, a mirror method, a tunnel method, and an sFlow method. The external apparatus performs a higher traffic analysis by employing the above-explained various information. In the traffic monitoring method of CLEAR-Flow, the operator is required to previously designate the observation basis with respect to the observation subject to the CLEAR-Flow classifier assembled in the switch. For example, as described in the non-patent publication 2, a setting operation is carried out which counts a total number of SYN packets which are transmitted to a specific port. Upon receipt of this setting operation, the router switch executes “observation”, and as a result of the detection, traffic data which is transmitted to the external apparatus becomes such a traffic data which is made coincident with a preset detecting condition. It should be noted that although not yet been publicly opened, one Japanese patent application has been filed under number of JP-A-2005-109744 as the patent application related to the present invention.

### BRIEF SUMMARY OF THE INVENTION

In the sFlow technique described in the non-patent publication 1, the router executes the sampling process operation of the traffics (packets) under transfer operation, and cuts out the sampled packet so as to form the traffic data packet. The traffic data packet outputted from the router corresponds to the cut out information as to the sampled respective packets. Inside the router apparatus, the storing operation of the information is not carried out, but also, the statistical analyzing process operation directed to the information contained in the header of the packet is not carried out. As a consequence, in such a case that a phenomenon of such a featured traffic as worms and DDOS (Distributed Denial Of Service) hidden in a traffic having a large capacity is sensed, traffic data packets outputted from the router become a large capacity in direct proportional thereto. Accordingly, there is such a problem that the sFlow packet producing load given to the router is increased, the load of transferring the sFlow packets to the traffic analyzing apparatus is increased, and further, the load given to the band of the network is increased.

In the CLEAR-Flow technical idea described in the above-explained non-patent publication 2, while the “observation” processing function is provided in the router, the router executes the focusing process operation of the subject traffic. The operator previously must designate the traffic subject to be detected with respect to the CLEAR-Flow classifier, and the router detects such a traffic which becomes conspicuous as the relevant traffic from the traffics which are made coincident with the set classifier condition (step 1-filter). The router is not equipped with a function capable of extracting a featured traffic from the entire traffics, but also not equipped with another function capable of summing up very small traffics so as to float up the featured track, which are executed by a traffic statistical analysis processing unit of the present invention, which is described in detail later.

Also, the router transfers the traffic only when the relevant traffic is detected (“analysis” stage), and need not continuously transfer the traffics to the traffic analyzing apparatus. As a result, the load of producing the relevant traffic information which should be transferred can be decreased, the load of transferring the relevant traffic information to the traffic analyzing apparatus can be decreased, and furthermore, the load given to the band of the network can be reduced. However, since the relevant traffic information to be transferred corresponds to copies of the respective packets, there is another problem that the transfer amount when the relevant traffic information is transferred is still large. In the CLEAR-Flow technical idea, a function for summing up to featured information is equipped in the traffic analyzing apparatus.

The present invention has been made to solve the problems described in the above-explained non-patent publications 1 and 2, and therefore, has an object to provide such a network control apparatus that the network control apparatus (either router or switch) analyzes a traffic, sums up the analyzed traffics to featured information, and thus, a transfer load/cost can be reduced.

To achieve the above-explained object, in the network control apparatus (either router or switch) of the present invention, a traffic statistical analysis processing unit is provided, and a featured traffic is monitored by this traffic statistical analysis processing unit. The traffic statistical analysis processing unit employs the following structure. That is, when the traffic statistical analysis processing unit detects the featured traffic, this traffic statistical analysis processing unit assembles information as to a feature element and a flow amount (time interval, and amount of traffics transferred within this time interval) into a packet, and then, transfers this summed-up information to a traffic analyzing apparatus. Also, the network control apparatus employs the following structure. That is, setting of an analyzing range (which information element of packet is to be analyzed) where the traffic statistical analyzing process operation of the network control apparatus is carried out may be changed from an upper grade apparatus (traffic analyzing apparatus etc.) based upon a parameter contained in control information.

### BRIEF DESCRIPTION OF THE DRAWINGS

FIG. 1 is a block diagram for schematically explaining an arrangement of a monitoring system of a traffic.

FIG. 2 is a block diagram for schematically indicating an arrangement of a network control apparatus according to a first embodiment of the present invention.

FIG. 3 is a block diagram for schematically showing an arrangement of a traffic analyzing apparatus.

FIG. 4 is an explanatory diagram for explaining a packet count table.

FIG. 5 is an explanatory diagram for explaining a threshold value table.

FIG. 6 is an explanatory diagram of explaining an abnormal sensing information table.

FIG. 7 is an explanatory diagram for explaining a packet of flow statistical information which has sensed an abnormal flow.

FIG. 8 is a flow chart for describing process operations of a traffic analyzing process unit.

FIG. 9 is a flow chart for describing abnormal judging process operations of the traffic analyzing process unit.

FIG. 10 is a diagram for explaining a control information packet which is transmitted by the traffic analyzing apparatus to the network control apparatus.

FIG. 11 is an explanatory diagram for explaining a packet of flow statistical information which has sensed an abnormal flow according to a second embodiment of the present invention.

FIG. 12 is an explanatory diagram for explaining a structural example of abnormal flow sensing information of a packet of the flow statistical information which has sensed the abnormal flow.

FIG. 13 is a schematic block diagram for explaining an arrangement of a traffic monitoring system which contains a network analyzing apparatus having a verification function according to a third embodiment of the present invention.

FIG. 14 is a diagram for showing a structural example of a verification packet which contains abnormal flow sensing information.

FIG. 15 is a diagram for representing another example of a packet count table.

FIG. 16 is a diagram for showing a structural example as to an item field contained in the abnormal flow sensing information of the packet of the flow statistical information which has sensed the abnormal flow.

### DETAILED DESCRIPTION OF THE INVENTION

Referring now to drawings, various embodiment modes of the present invention will be described by employing embodiments.

### First Embodiment

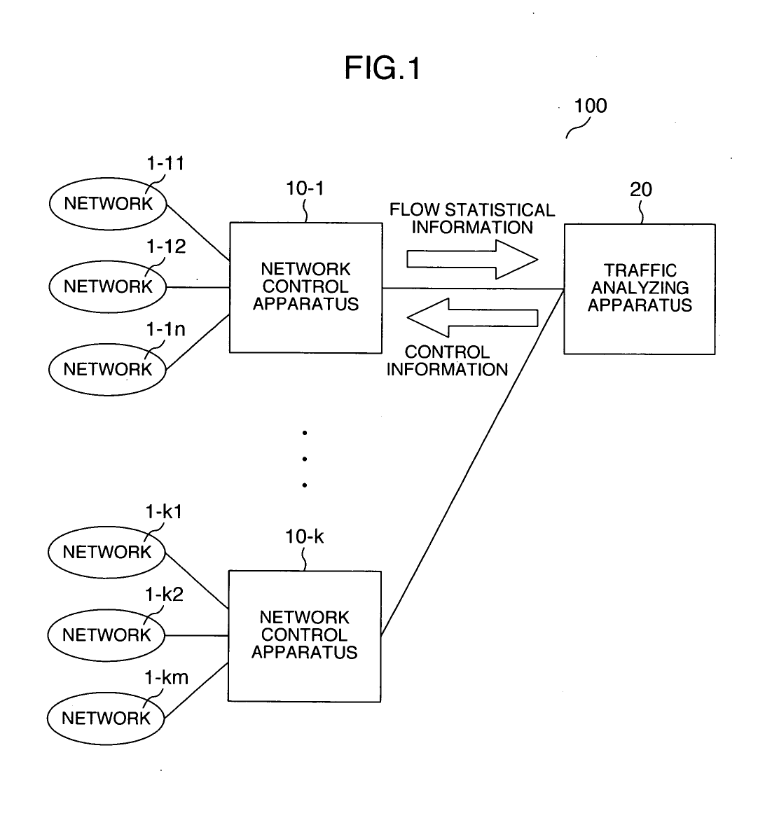

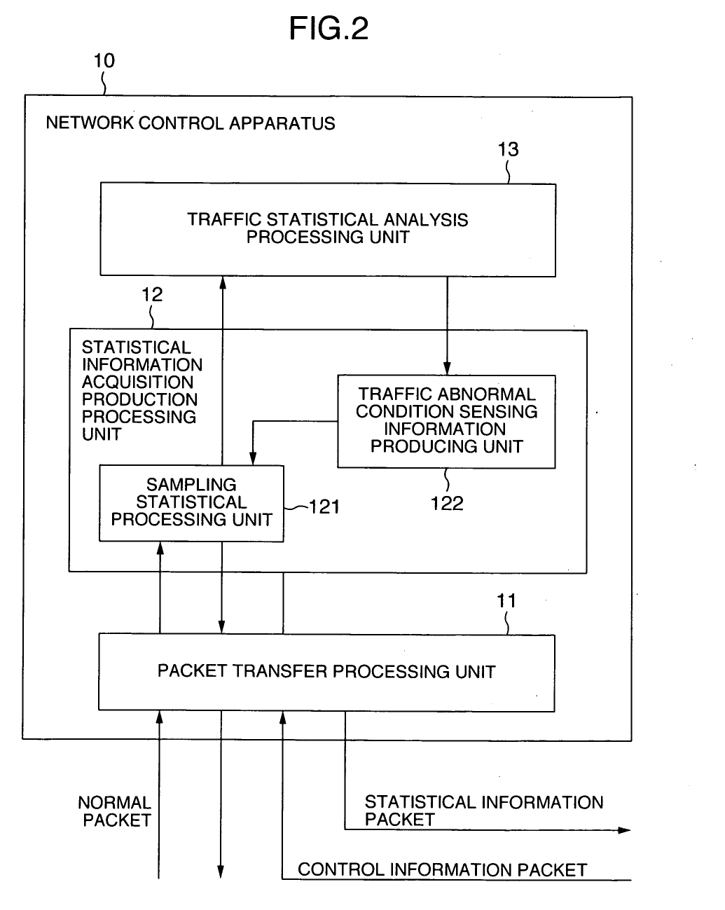

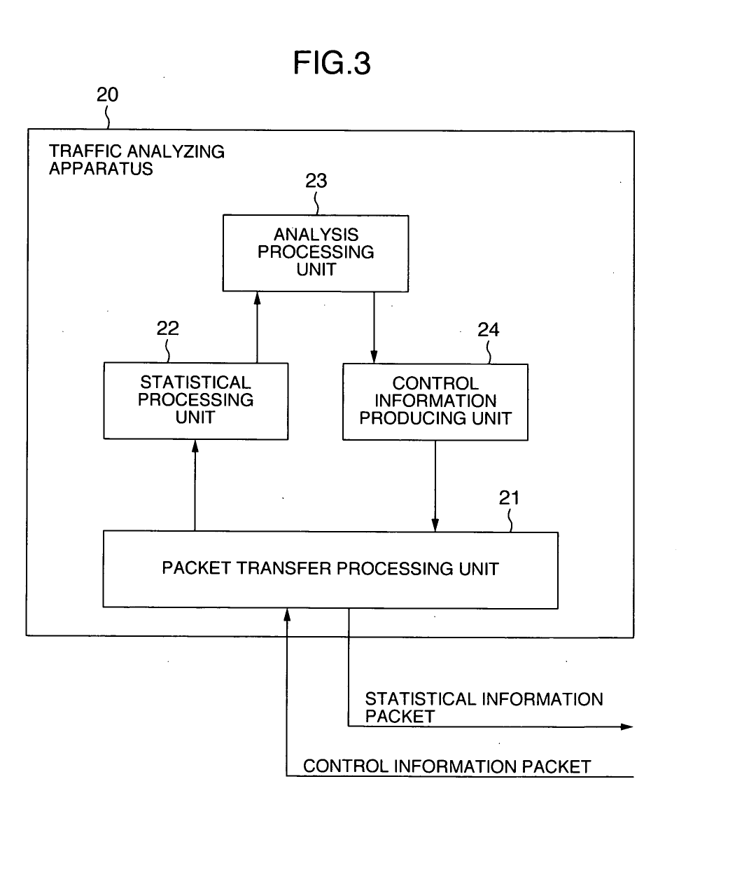

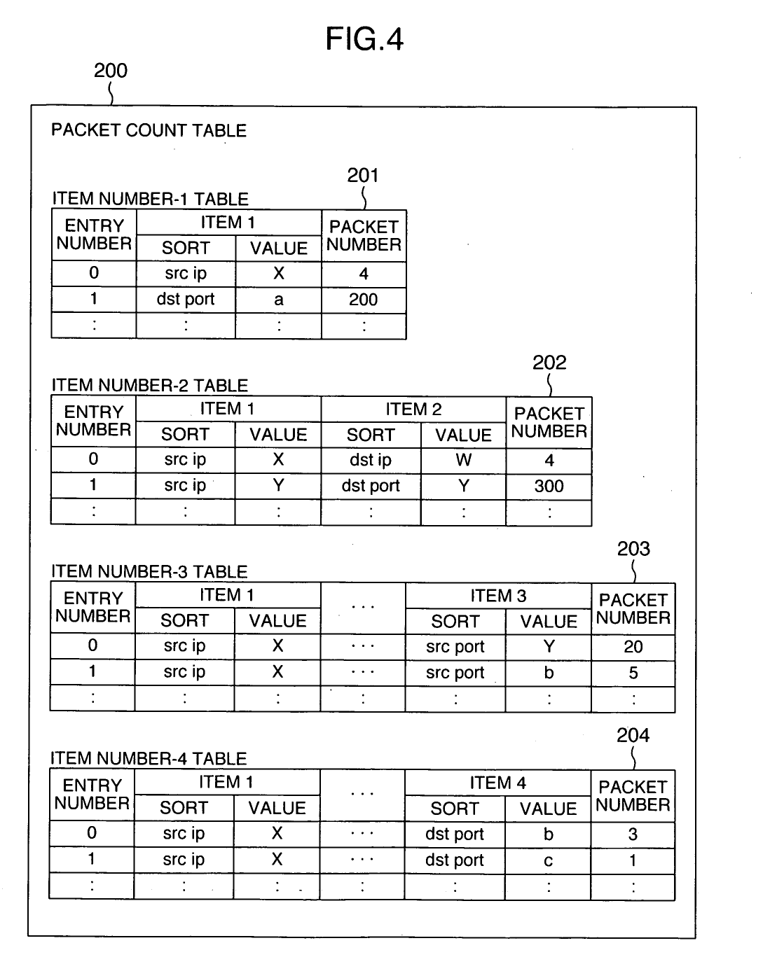

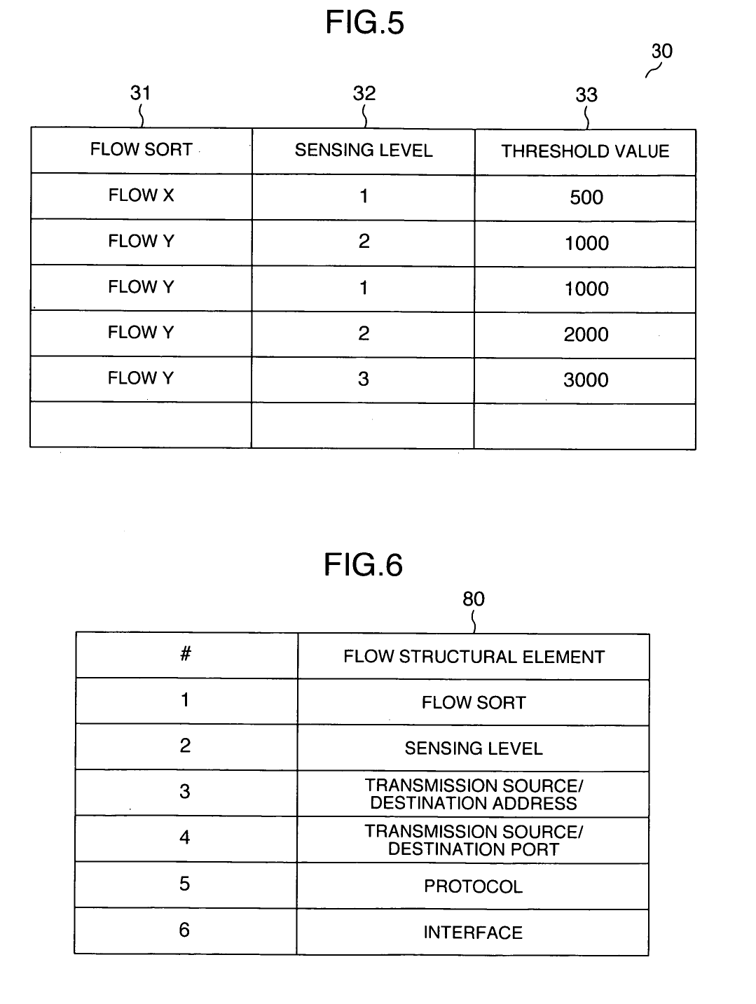

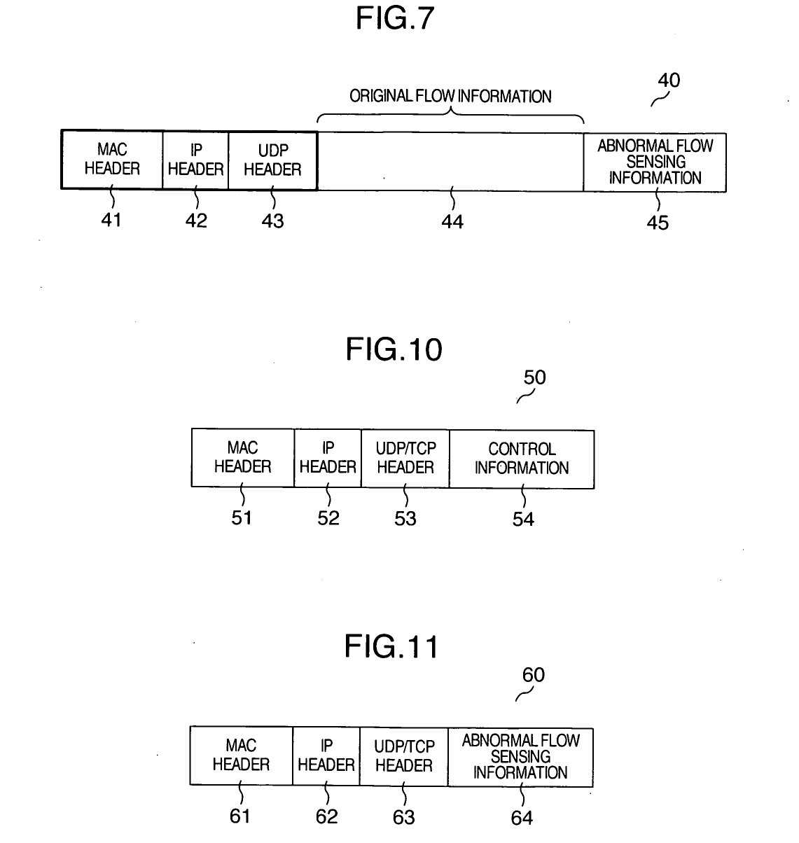

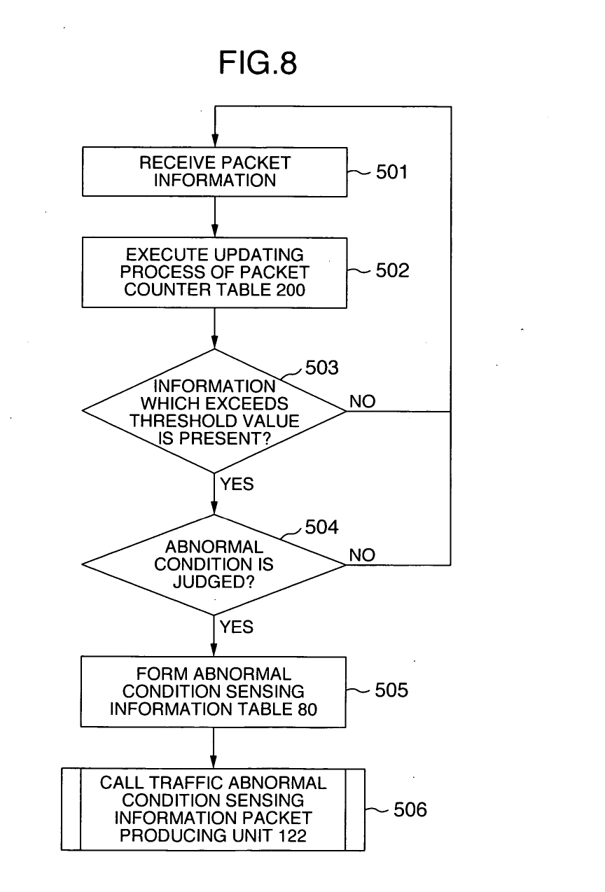

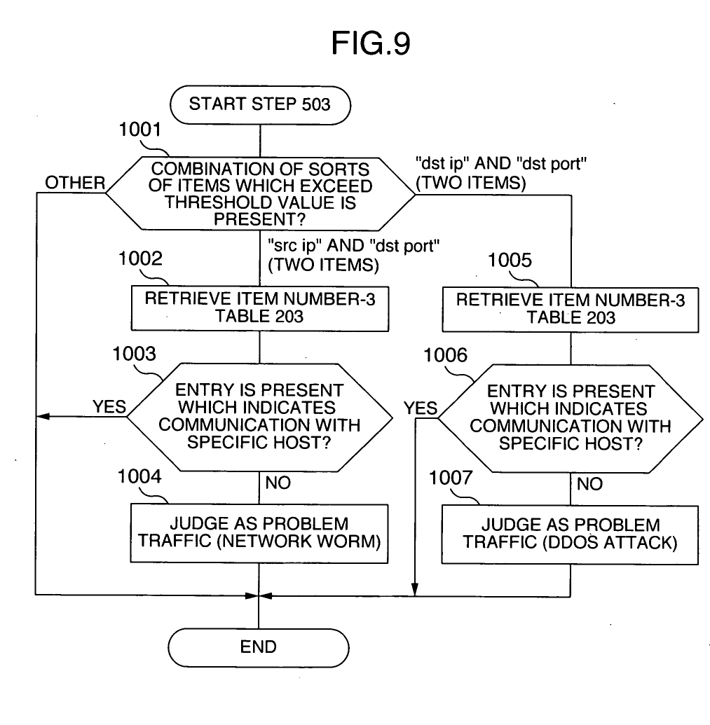

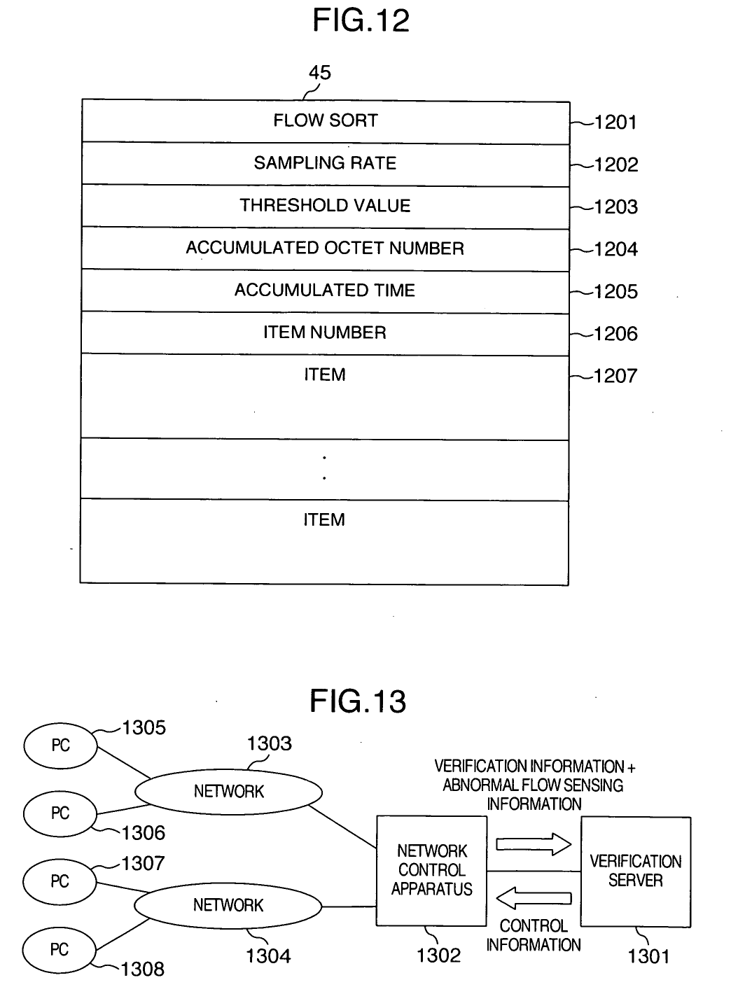

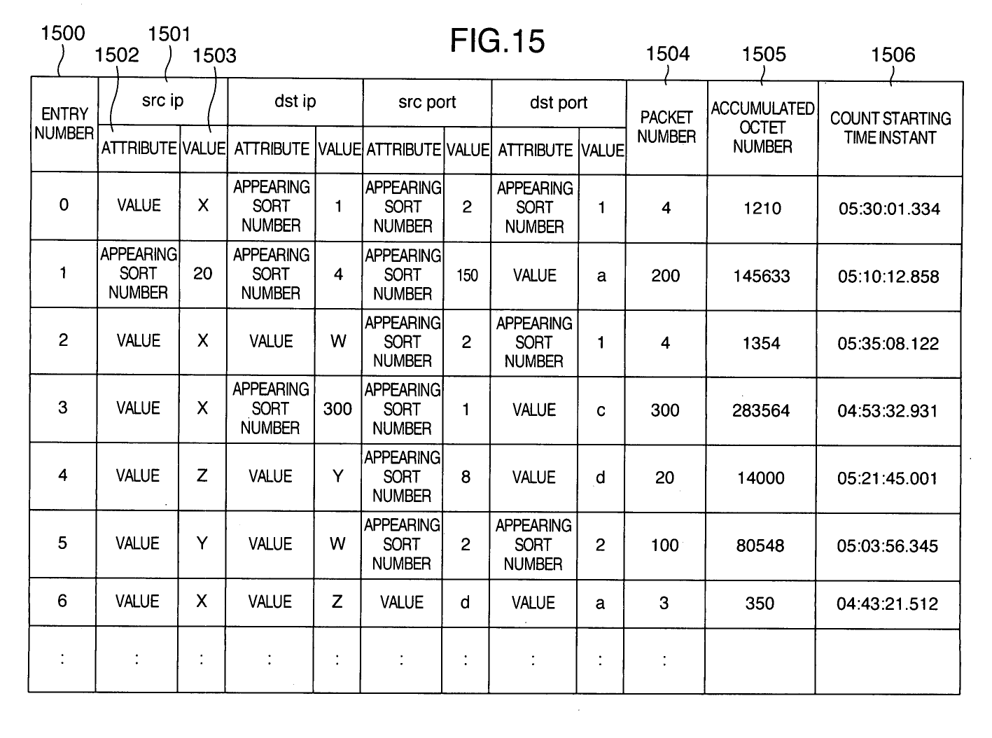

A first embodiment of the present invention will now be explained with reference to FIG. 1 to FIG. 10, FIG. 12, FIG. 15, and FIG. 16. In this case, FIG. 1 is a block diagram for explaining an arrangement of a monitoring system of a traffic. FIG. 2 is a block diagram for indicating an arrangement of a network control apparatus. FIG. 3 is a block diagram for schematically showing an arrangement of a traffic analyzing apparatus. FIG. 4 and FIG. 15 are explanatory diagrams for explaining packet count tables. FIG. 5 is an explanatory diagram for explaining a threshold value table. FIG. 6 is an explanatory diagram of explaining an abnormal sensing information table. FIG. 7, FIG. 12, and FIG. 16 are explanatory diagrams for explaining packets of flow statistical information which has sensed abnormal flows. FIG. 8 is a flow chart for describing process operations of a traffic analyzing process unit. FIG. 9 is a flow chart for describing abnormal judging process operations of the traffic analyzing process unit. FIG. 10 is a diagram for explaining a control information packet which is transmitted by the traffic analyzing apparatus to the network control apparatus.

In FIG. 1, a monitoring system 100 of a traffic is arranged by a network control apparatus 10-1, another network control apparatus 10-K, and a traffic analyzing apparatus 20. The network control apparatus 10-1 is connected to a plurality of networks 1-11, 1-12, - - - , 1-1n. The network control apparatus 10-K is connected to a plurality of networks 1-K1, 1-K2, - - - , 1-Km. The network control apparatus 10 transmits flow statistical information to the traffic analyzing apparatus 20. Conversely, the traffic analyzing apparatus 20 transmits control information (parameter and the like) to the network control apparatus 10.

In this monitoring system 100, the above-explained flow statistical information contains abnormal information detected by the network control apparatus 10. Also, the above-explained control information contains a reset of a counter and a change of a threshold value level (increasing instruction of threshold value), which are judged by the traffic analyzing apparatus 20 based upon the abnormal information. Conversely when abnormal traffics are small, a decreasing instruction of the threshold value is contained in the control information. Since the monitoring system 100 is arranged in the above-explained manner, an abnormal traffic is analyzed/sensed by the network control apparatus 10, so that the threshold value level can be changed in response to a condition of an abnormal traffic. As a result, the threshold value level can become a sensitivity in response to the condition of the abnormal traffic. It should be understood that an arrow indicating flow statistical information, and an arrow indicating control information between the traffic analyzing apparatus 20 and the network control apparatus 10-K have been omitted, for the sake of a simple illustration.

The network control apparatus 10 shown in FIG. 2 is arranged by a packet transfer processing unit 11, a statistical information acquisition producing unit 12, and a traffic statistical analysis processing unit 13. Also, the statistical information acquisition producing unit 12 is arranged by a sampling statistical processing unit 121, and a traffic abnormal condition sensing information packet producing unit 122.

A normal packet is transferred to a transfer destination by the packet transfer processing unit 11. Also, as to the normal packet, a copy thereof is transferred from the packet transfer processing unit 11 to the sampling statistical processing unit 121. The sampling statistical processing unit 121 samples packets to be sampled at a predetermined ratio so as to cut out N bytes which contain headers of the packets to be sampled. The sampling statistical processing unit 121 produces such a packet (sFlow packet) which has been stored in a payload by superimposing portions of the cut packets with each other, and then, transfers the formed packet as a statistical information packet via the packet transfer processing unit 11 to the traffic analyzing apparatus 20.

Also, the sample statistical processing unit 121 transfers the packet to be sampled to the traffic statistical analysis processing unit 13. The traffic statistical analysis processing unit 13 previously receives a control information packet sent from the traffic analyzing apparatus 20 via the packet transfer processing unit 11, and a threshold value has been set. The traffic statistical analysis processing unit 13 senses a traffic abnormal condition by using this threshold value. The traffic statistical analysis processing unit 13 which has sensed the traffic abnormal condition transfers abnormal condition sensing information to the traffic abnormal condition sensing information packet producing unit 122. The traffic abnormal condition sensing information packet producing unit 122 produces an abnormal condition sensing information packet based upon the abnormal condition sensing information, and then, transfers this produced abnormal condition sensing information packet to the sampling statistical processing unit 121. The sampling statistical processing unit 121 which has received the abnormal condition sensing information packet adds abnormal flow sensing information to an sFlow packet so as to form a statistical information packet, and then, transfers the statistical information packet via the packet transfer processing unit 11 to the traffic analyzing apparatus 20.

Since the threshold value of the network control apparatus 10 according to this first embodiment can be externally varied, this network control apparatus 10 can be arranged as a network control apparatus capable of sensing a traffic abnormal condition, while a control parameter is variable.

The traffic analyzing apparatus 20 shown in FIG. 3 is constituted by a packet transfer processing unit 21, a statistical processing unit 22, an analysis processing unit 23, and a control information packet producing unit 24. The statistical information packet transferred from the network control apparatus 10 is transferred via the packet transfer processing unit 21 to the analysis processing unit 22 so as to receive a statistical processing operation. The statistical processing unit 22 transfers a statistical processing result to the analysis processing unit 23. The analysis processing unit 23 executes an analysis processing operation by employing the statistical processing result. The analysis processing unit 23 resets a count value of a packet count table (will be explained later) of the network control apparatus 10 which detects a traffic abnormal condition based upon the analytical processing result, and increases a threshold value of the count value. Concretely speaking, the control information packet producing unit 24 produces such a packet which controls a resetting operation of the count value and a changing operation of the threshold value, and transfers the produced packet via the packet transfer processing unit 21 to the network control apparatus 10.

The packet count table 200 indicated in FIG. 4 corresponds to a table which is held in the traffic statistical analysis processing unit 13. The packet count table 200 is constituted by an item number-1 table 201 an item number-2 table 202, an item number-3 table 203, and an item number-4 table 204. The item number-1 table 201 has held packet numbers counted by the traffic statistical analysis processing unit 13 in correspondence with sorts and values of an item 1. In this table, symbol “src ip” indicates “source ip”, and implies an IP address of a transmission source. Also, symbol “dst port” indicates “destination port”, and implies a port number of a transmission destination.

In the item number-2 table 202, packet numbers are counted under AND condition between the sorts/numbers of the item 1 and the sorts/numbers of the item 2. In the item number-3 table 203 and the item number-4 table 204, packet numbers are counted under AND condition of either the item number 3 or the item number 4. The packet numbers of the packet count table 200 are reset in a predetermined interval. Also, the resetting operation may be carried out based upon the control information transmitted by the traffic analyzing apparatus 20.

Item columns of the packet count table are selected from information of packets. As an example of the packet information, there are such information contained in various headers (IP header, TCP header, UDP header, MPLS header, MAC header etc.), hash values of payload data, and the like. In view of this implication, in the packet count table 200, a total arrival number of these packets is counted based upon the header information.

A packet count table 1500 of FIG. 15 corresponds to another embodiment as to the packet count table 200 shown in FIG. 4.

In this first embodiment, items for discriminating traffics from each other are made of 4 sorts, namely, a transmission source IP address (src ip), a destination IP address (dst ip), a transmission source port number (src port), and a destination port number (dst port). A combination of arbitrary “n” items (1≦n≦4) selected from the above-explained 4 sorts of items is produced. The above-explained item sorts are indicated in an item field 1501.

It should also be noted that although a total number of the items to be processed is selected to be 4 sorts in this embodiment, another item may be furthermore added, or may be deleted in response to a characteristic of a traffic which is wanted to be sensed. For instance, in order to extract such a traffic related to an establishing process and a cutting process of a TCP cession, flag information contained in a TCP header may be alternatively involved in these items to be processed. Alternatively, in order to more correctly grasp a characteristic of a traffic, several bytes of a head portion as to application data which succeeds either a TCP header or a UDP header may be involved in the items to be processed. Otherwise, in the case that an MPLS label is attached, an analysis of a traffic for every LSP may be alternatively carried out by also involving the value of the above-explained MPLS label. Also, when a tunneling protocol such as L2TP is used, an analysis of a traffic which passes through each of the tunnels may be alternatively carried out by involving a tunnel identifier.

A value field 1503 of the packet count table 1500 stores thereinto a value of such an item if this item constitutes the above-described combined structural element, and if an item does not constitute above-explained combined structural element, then a total number of sorts as to values of the above-described items appeared in a count of a packet having the above-described combined structural element is stored in this value field 1503. Information for indicating as to whether a numeral value stored in the value field 1503 corresponds to the value, or the total number of appearing sort is stored in an attribute field 1502.

For instance, an entry of an entry number 4 in FIG. 15 represents that 20 pieces of such a packet appears that the transmission source IP address is “Z”, the destination IP address is “Y”, and the destination port number is “d”, and also represents that sorts of the transmission source port numbers contained in the above-explained 20 packets become 8 sorts.

Furthermore, the respective entries of the packet count table 1500 own a packet number field 1504, an accumulated octet number field 1505, and a count starting time instant field 1506. The packet number field 1504 is used to count a packet number for each entry. The accumulated octet number field 1505 is used to accumulate a length of a packet to be counted in the above entry. The count starting time instant field 1506 holds a time instant when a counting operation of a packet number is started in the above entry.

The packet count table 1500 owns a different point from the above-explained packet count table 200. That is, when a packet number for paying an attention to a combination of certain items is counted, at the same time, such a counting operation is carried out for counting how many different values appear as to an item which is not involved in the combination of the items.

The threshold value table indicated in FIG. 5 corresponds to a table which is held in the traffic statistical analysis processing unit 13 of the network control apparatus 10. The threshold value table 30 is constituted by a flow sort 31, a sensing level 32, and a threshold value 33. Concretely speaking, the flow sort 31 corresponds to a traffic abnormal condition such as a worm and DDoS. In this case, when packets of a flow X exceed 500 to be detected, the sensing level is judged as a sensing level 1. When packets of the flow X exceed 1000 to be detected, the sensing level is judged as a sensing level 2. It should also be understood that these threshold values are written based upon control information supplied from the traffic analyzing apparatus 20.

The abnormal condition sensing information table 80 indicated in FIG. 6 corresponds to such a table which is produced by the traffic statistical analysis processing unit 13 of the network control apparatus 10, and then, is transferred to the traffic abnormal condition sensing information packet producing unit 122. The abnormal condition sensing information table 80 corresponds to a table in which flow structural elements are coupled to each other in a serial manner. Concretely speaking, this abnormal condition sensing information table 80 is constituted by a flow sort such as DDoS and a worm of a detected flow; a sensing level equal to a suspection degree of the detected flow; a transmission source/destination address as information of a TCP/IP header; a transmission source/destination port; a protocol sort of a layer 4; and also, an interface which corresponds to network interface information of a network control apparatus. Other information such as information as to a layer 2 and application software may be stored in the abnormal condition sensing information table 80.

A packet (FIG. 7) 40 of flow statistical information from which an abnormal flow has been sensed corresponds to a packet which is produced by the sampling statistical processing unit 121 of the network control apparatus 10. The flow information packet 40 is constituted by an MAC header 41, an IP header 42, a UDP header 43, flow information 44, and abnormal flow sensing information 45. A packet which is arranged by the MAC header 41, the IP header 42, the UDP header 43, and the flow information 44 corresponds to a packet of sFlow. However, the abnormal flow sensing information 45 is included in the flow information packet 40, which implies that the network control apparatus 10 has detected an abnormal condition of a traffic.

A structural example of the abnormal flow sensing information 45 will now be explained with reference to FIG. 12 and FIG. 16.

The abnormal flow sensing information 45 is constituted by a flow sort 1201, a sampling rate 1202, a threshold value 1203, an accumulated octet number 1204, an accumulation time 1205, an item number 1206, and a plurality of items 1207. The flow sort 1201 indicates a sort of a sensed flow. Sort information, for example, DDoS and a worm is entered as a value of the flow sort 1201. The sampling rate 1202 shows a packet sampling rate when a flow is sensed, and a sampling rate held by the sampling statistical processing unit 121 is stored in the sampling rate 1202. The threshold value 1203 represents such a threshold value of a packet count number which triggers a notification of this message, while any one of the threshold values 33 of the threshold value table 30 is stored in this threshold value 1203. The accumulated octet number 1204 indicates a total octet number of packet lengths which have been received until the packet count value exceeds the threshold value, while a value of the accumulated octet number field 1505 of the entry of the packet count table 1500 where the packet number field 1504 exceeds the threshold value is stored in this accumulated octet number 1204.

The entry accumulated time 1205 indicates a time defined after a counting operation for a packet count number of a flow notified by this message is commenced until the counted packet number exceeds the threshold value. A difference between the present time instant and the value of the count starting time instant 1506 of the entry of the packet count table 1500 in which the packet number field 1504 exceeds the threshold value is stored in this entry accumulated time 1205. The item number 1206 shows a total number of items 1207 which are contained in this message. In an example of the packet count table 1500, since one entry is constructed of 4 pieces of items, the value of the item number 1206 becomes 4. The item 1207 represents contents of the respective items which are contained in the entry of the packet count table 1500 in which the packet number 1504 exceeds the threshold value.

The item 1207 owns such a structure as shown in FIG. 16. An item 1601 indicates a sort of an item. Concretely speaking, such an identification information as “src ip” and “dst ip” represented in the item field 1501 of the packet count table 1500 is stored in this item 1601. In an attribute 1602, either “value” or “appearing sort number” indicated in the attribute field 1502 of the packet count table 1500 is stored. In a value 1603, a value indicated in the value field 1503 of the packet count table 1500 is stored.

When the network control apparatus 10 detects an abnormal flow, since the network control apparatus 10 transmits the packet containing the above-explained information to the traffic analyzing apparatus 20, the traffic analyzing apparatus 20 can grasp the sort, the scale, and the duration time of the abnormal flow based upon the above-described information with a short time under low processing load.

Next, a description is made of operations as to the traffic statistical analysis processing unit 13 of the network control apparatus 10 with reference to FIG. 8. A packet sampled by the sampling statistical processing unit 121 is received by the traffic statistical analysis processing unit 13 (step S501). The traffic statistical analysis processing unit 13 increments a packet number of the relevant entries (generally speaking, plural entries are present) of the packet counter table 200 shown in FIG. 4 by employing the header information of the packet (step S502). In the case that there is no relevant entry, an entry is newly formed. In this case, a combination of items contained in the above-described header information of the entry which is newly formed may be previously set, and furthermore, may be changed based upon the control information 54 of the control information packet 50. Next, a check is made as to whether or not such an entry is present which exceeds the threshold value of the sensing level 1 among the combination of items indicative of suspicious flows with reference to both the item number-2 table 202 and the threshold value table 30 shown in FIG. 5 (step S503). When there is no entry (“NO”), the process operation is returned to the previous step S501, whereas when there is such an entry (“YES”), the process operation is advanced to an abnormal condition judging operation. When it is so judged that an abnormal condition is present (“YES”) in the abnormal condition judging operation (step S504), the abnormal condition sensing information table 80 shown in FIG. 6 is formed by again referring to the threshold value table 30 (step S505). When it is so judged that an abnormal condition is not present (“NO”), the process operation is returned to the step S501. The traffic statistical analysis processing unit 13 transfers the abnormal condition sensing information table 80 to the traffic abnormal condition sensing information producing unit 122 (step S506).

Referring now to a flow chart of FIG. 9, the above-explained steps S503 and S504 of FIG. 8 will be described more in detail as detecting flows for a network worm and DDoS.

Firstly, a judgement is made as to whether or not there is a combination between a sort and a value of an item which exceeds the threshold value in the item number-2 table 202 (step S1001). In the case that there is such a combination other than a combination between “scr jp” and “dst port”, and another combination between “dst ip” and “dst port”, the detecting flow operation is ended.

When the combination between the sort and the value of the item which exceeds the threshold value in the item nubmer-2 table 202 corresponds to “scr ip” and “dst port”, the item number-3 table 203 is retrieved (step S1002). In the item number-3 table 203, a confirmation is made as to whether or not an entry indicative of a communication with respect to a specific host is present, while both “scr ip” and “dst port” are identical to those of this entry (step S1003). In this case, as the item indicative of the communication with respect to the specific host, “dst ip” is employed. When the confirmation result becomes “YES”, it is so judged that the traffic is not the worm, the detecting flow operation is ended. On the other hand, when the confirmation result becomes “NO”, it is so judged that the traffic is the worm (step S1004).

On the other hand, when the combination between the sort and the value of the item which exceeds the threshold value in the item number-2 table 202 corresponds to “dst ip” and “dst port”, the item number-3 table 203 is retrieved (step S1005). In the item number-3 table 203, a confirmation is made as to whether or not an entry indicative of a communication with respect to a specific host is present, while both “scr ip” and “dst port” are identical to those of this entry (step S1006). In this case, as the third item indicative of the communication with respect to the specific host, “scr ip” is employed. When the confirmation result becomes “YES”, it is so judged that the traffic corresponds to a P2P communication between two specific terminals, and is not DDOS, the detecting flow operation is ended. On the other hand, when the confirmation result becomes “NO”, it is so judged that the traffic corresponds to DDoS equal to a communication from a plurality of transmission sources to a specific destination (step S1007).

Returning back to FIG. 2, the traffic abnormal condition sensing information producing unit 122 which has received the abnormal condition sensing information table 80 produces the abnormal flow sensing information 45 shown in FIG. 7 from the received abnormal condition sensing information table 80. The traffic abnormal condition sensing information producing unit 122 transfers the produced abnormal flow sensing information 45 to the sampling statistical processing unit 121. The sampling statistical processing unit 121 transfers such a flow statistical information packet 40 in which the abnormal flow sensing information 45 is added subsequent to the normal sFlow packet to the traffic analyzing apparatus 20.

At the same time, the network control apparatus 10 sets a filter (not shown) to the output unit of the packet transfer processing unit 11 so as to stop transferring operation of an abnormal packet.

In FIG. 3, in the traffic analyzing apparatus 20 which receives the flow statistical information packet 40 to which the abnormal flow sensing information 45 has been added, the flow statistical information packet 40 is analyzed by the analyzing process unit 23, and in such a case that the abnormal level of the flow X shown in FIG. 5 is higher than, or equal to the sensing level 2, the traffic analyzing apparatus 20 judges that no more sensing operation can be carried out. As a result, the control information packet 50 is transmitted via the control information producing unit 24 to the network control apparatus 10 in order that the packet count table should be reset, the threshold value of the sensing level 1 of the flow X should be selected to be 1000, and the threshold value of the sensing level 2 thereof should be selected to be 2000.

A control information packet 50 which is indicated in FIG. 10 and is transmitted by the traffic analyzing apparatus 20 to the network control apparatus 10 is produced by the control information packet producing unit 24 of the traffic analyzing apparatus 20. The control information packet 50 is constituted by an MAC header 51, an IP header 52, a UDP header 53, and control information 54. This control information 54 is constituted by a counter reset signal, a parameter, and the like.

It should also be understood that although the packet has been exemplified as sFlow in the above-described first embodiment, either NetFlow or mirrored packet may be alternatively employed, and also, the present invention is not limited only thereto. Alternatively, information for changing the combination setting information of the items whose packets should be counted in the packet count table may be involved in the control information 54, or such an information for changing the flow sorts and the sensing levels of the threshold value table may be involved in the control information 54. Furthermore, the threshold values of the sensing levels 1 and 2 of the flow X are not changed, but a sensing level 3 (threshold value being 3000) may be newly provided.

Also, an issuing destination of notifying an abnormal condition when a traffic abnormal condition happens to occur is not limited only to a traffic analyzing apparatus, but may be alternatively directed to an upper grade of a network monitoring apparatus.

In accordance with this first embodiment, the analysis of the abnormal traffic and the analysis of the overloaded traffic can be carried out by the network control apparatus (routers, or switches) which are arranged in the distribution manner. As a result, the analyzing load given to the traffic analyzing apparatus (collector, or analyzer) can be reduced. Also, since the analysis information of the abnormal traffic is added to the conventional sFlow statistical information, the function can be expanded while utilizing the function of the conventional Flow statistical calculation sever. Furthermore, in accordance with this first embodiment, since the setting conditions as to the packet counter table and the threshold value table are changed in response to attacking patterns, even such a network attack which will newly occur in future may be avoided.

In this first embodiment, when an algorithm whose process load is low is applied to the traffic statistical analysis processing unit 13, and this traffic statistical analysis processing unit 13 is built in the network control apparatus 10, and then, the network control apparatus. 10 executes the traffic analyzing operation and the information collecting operation, the workload of the network control apparatus 10 for transferring the packets to the traffic analyzing apparatus 20 can be reduced. Furthermore, the load to the network band can be reduced.

In addition, the executions of traffic analyzing operations can be distributed to the respective network control apparatus 10. As a result, the processing load and the cost of the traffic analyzing apparatus 20 can be reduced.

### Second Embodiment

A second embodiment of the present invention will now be explained with reference to FIG. 11. A system arrangement of this second embodiment is similar to that of the first embodiment. FIG. 11 is an explanatory diagram for explaining a packet of flow statistical information which has sensed an abnormal flow, according to this second embodiment.

The packet of the flow statistical information which has sensed the abnormal flow, indicated in FIG. 11, corresponds to such a packet which is produced by the sampling statistical processing unit 121 of the network control apparatus 10. A flow information packet 60 is constituted by an MAC header 61, an IP header 62, a UDP header 63, and abnormal flow sensing information 64.

In this second embodiment, only the abnormal flow sensing information 64 is transferred to the traffic analyzing apparatus 20. As a consequence, the sampling statistical process operation of the sampling statistical processing unit 121 can be simplified.

Also, an issuing destination of notifying an abnormal condition when a traffic abnormal condition happens to occur is not limited only to a traffic analyzing apparatus, but may be alternatively directed to an upper grade of a network monitoring apparatus. Similar to the normal packet, the abnormal packet may be notified via a network to a PC of a network manager.

### Third Embodiment

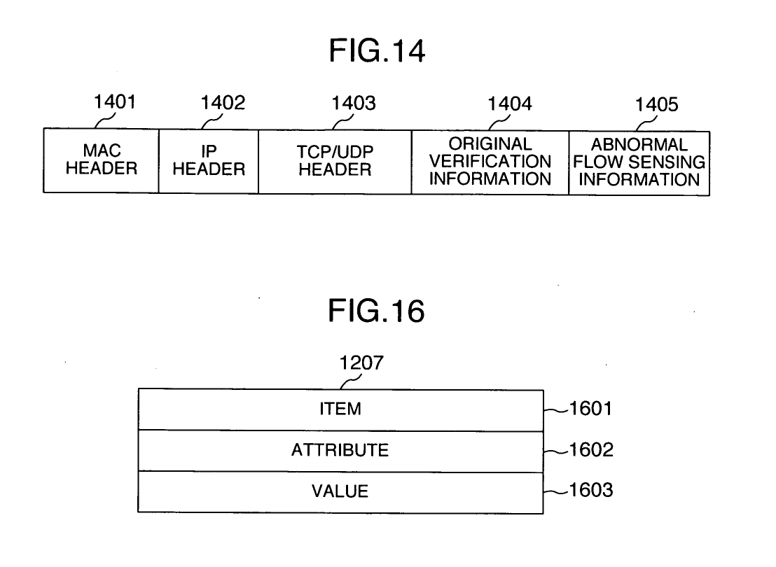

Referring now to FIG. 13 and FIG. 14, a third embodiment will be described. FIG. 13 indicates a verification system which is equipped with verification server 1301 having a verification function such as the RADIUS protocol, while the verification server is used as a traffic analyzing apparatus. The verification system shown in FIG. 13 is arranged by a plurality of networks 1303 and 1304 connected to a plurality of PCs (personal computers) 1305 to 1308; a network control apparatus 1302 connected to the plural networks 1303 and 1304; and the verification server 1301. The PCs 1305 to 1308 are verified by the verification server 1301 via the network control apparatus 1302. The network control apparatus 1302 transmits abnormal traffic sensing information of the relevant PC at timing of verification/re-verification to the verification server 1301. The verification server 1301 performs verification by using verification information, and performs a traffic control operation of the relevant PC by using the abnormal traffic sensing information.

The abnormal traffic sensing information has been added to a verification packet in addition to original verification information as shown in FIG. 14.

In accordance with this third embodiment, since the abnormal traffic is analyzed/sensed by the network control apparatus 1302, a work load given to the traffic analyzing apparatus 20 can be reduced, a work load of transferring packets to the traffic analyzing apparatus 20 can be reduced, and further, a load given to the network band can be lowered.

Also, in accordance with this third embodiment, in the system for verifying the PCs via the network control apparatus 1302, since the abnormal traffic sensing information in the unit of PC is notified from the network control apparatus 1302 to the verification server 1301 when the verifying/re-verifying operations are carried out, the dynamic traffic information is added in addition to the static verification information (password, digital signature information, and the like). As a result, the traffic control operation of the relevant PC can be carried out in addition to the verification function.

It should be further understood by those skilled in the art that although the foregoing description has been made on embodiments of the invention, the invention is not limited thereto and various changes and modifications may be made without departing from the spirit of the invention and the scope of the appended claims.

1. A network control apparatus arranged between a network and a traffic analyzing apparatus, for transferring a packet with respect to said network, comprising:
means for receiving control information transmitted by said traffic analyzing apparatus;
means for monitoring said packet by employing a parameter contained in said control information; and
means for transmitting the detected traffic abnormal information to said traffic analyzing apparatus when a traffic abnormal condition is detected.

2. A network control apparatus as claimed in claim 1, further comprising:
means for counting a total arrival number of packets based upon header information of said packet; and wherein:
said total arrival number is reset based upon said control information.

3. A network control apparatus as claimed in claim 2, further comprising:
means for setting a threshold value corresponding to a flow sort; wherein:
means for judging a traffic abnormal condition with reference to said packet count table when said total arrival number exceeds said threshold value.

4. A network control apparatus arranged between a network and a traffic analyzing apparatus, in which a packet transfer processing unit is provided so as to transfer a packet with respect to said network, comprising:
a sampling statistical processing unit for sampling a received packet; and
a traffic statistical analysis processing unit for detecting an abnormal traffic.

5. A network control apparatus as claimed in claim 4, wherein:
when said traffic statistical processing unit detects the traffic abnormal condition, said network control apparatus transmits abnormal condition detecting notification to said traffic analyzing apparatus.

6. A network control apparatus as claimed in claim 4, wherein:
when said traffic statistical processing unit detects the traffic abnormal condition, said network control apparatus stops to transfer a packet of said traffic abnormal condition.

7. A network control apparatus as claimed in claim 4, wherein:
a traffic abnormal condition detecting parameter of said traffic statistical processing unit can be changed based upon the control information supplied from said traffic analyzing apparatus.

8. A control method of a network control apparatus, comprising:
a step for receiving a packet from a network;
a step for updating a total arrival number of a packet counter table based upon header information of the received packet;
a step for comparing said total arrival number with a predetermined threshold value;
a step for executing an abnormal condition judging operation when said total arrival number exceeds said predetermined threshold value; and
a step for transmitting traffic abnormal condition notification when the traffic abnormal condition is judged.

9. A control method of a network control apparatus as claimed in claim 8 wherein:
a transmission destination of said traffic abnormal condition notification is a traffic analyzing apparatus.

10. A control method of a network control apparatus as claimed in claim 8 wherein:
said received packet corresponds to a packet which has been sampled.

11. A system comprising a PC (personal computer), a network control apparatus, and a verification server being connected via a network to each other for verifying said PC, wherein:
said network control apparatus transmits abnormal traffic information of said relevant PC to said verification server when verifying/re-verifying operations are carried out.

12. A network control apparatus as claimed in claim 1 wherein:
said detected abnormal information contains an item for specifying information related to either a transmission source or a reception destination of a packet to be transmitted, an attribute of said item, and a value of said item.
